(19) United States
(12) Patent Application Publication
(10) Pub. No.: US 2010/0153482 A1
(43) Pub. Date: Jun. 17, 2010

(54) Cloud-Based Automation of Resources

(75) Inventors: Danny Kim, Bellevue, WA (US); Hakjae Robert Chung, Bellevue, WA (US); Paul R. Thompson, Arlington, WA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Full Armor Corporation, Boston, MA (US)

(21) Appl. No.: 12/634,050

(22) Filed: Dec. 9, 2009

Related U.S. Application Data
(60) Provisional application No. 61/201,408, filed on Dec. 10, 2008.

(51) Int. Cl. G06F 15/16

(52) U.S. Cl. 709/201

(57) ABSTRACT

In an example embodiment, workflow based procedures are authored, tested and converted to a collection of resource automation scripts with orchestration rules. The scripts and rules are uploaded to a cloud-based provisioning service. The cloud-based provisioning service follows the orchestration rules to coordinate with a provisioning agent installed on a VM host, storage area network (SAN) or other network device to execute a sequence of scripts to provision or tear down resources.

### RELATED APPLICATION

This application claims the benefit of U.S. Provisional Application No. 61/201,408, filed on Dec. 10, 2008. The entire teachings of the above application are incorporated herein by reference.

### BACKGROUND

An information technology data center is a physical facility that houses computer systems and associated components, such as telecommunication network devices and storage systems. The data center typically includes redundant or backup power supplies, redundant data communications connections, environmental controls and security devices. The data center is undergoing a transformation in which new server and client virtual machines (VMs) are being provisioned instead of building out conventional physical machines. Software application services run on these VMs. The advantages of this approach include reduction in hardware costs, reduction in power consumption and efficiency gains through faster provisioning. Currently, the provisioning of VMs and the application services running on them is done either through proprietary software from VM and software vendors installed and run from the data center or custom scripts written and maintained by an administrator within the data center.

### SUMMARY

Embodiments of the subject innovation allow creation of workflow based procedures to be authored, tested and converted to a collection of scripts with orchestration rules. The scripts and rules may be packaged by an administrator and uploaded to a cloud-based provisioning service. The cloud-based provisioning service follows the orchestration rules to coordinate with an agent installed on a VM host, storage area network (SAN) or other network device to execute a sequence of scripts to provision or tear down resources.

An advantage of using a cloud-based provisioning and tear down approach in accordance with the subject innovation is that it removes the need for additional runtime and provisioning servers to be deployed to a customer's data center. In addition, the scalability of the cloud-based service provides dynamic provisioning resources to execute and track any size.

Accordingly, a method at a workstation comprises converting a workflow to plural scripts, generating orchestration rules that define flow logic for executing the scripts in a defined sequence and sending the scripts and orchestration rules to a cloud-based service. A method at an endpoint comprises receiving a script from a cloud-based service; executing the script; generating status information associated with execution of the script; and sending the script status information to the cloud-based service. The method at the endpoint may further include receiving event trigger information indicating occurrence of a particular monitored event, sending the event trigger information to the cloud-based service and receiving the script in response to the sent event trigger information.

A method of providing a cloud-based service comprises receiving plural scripts and orchestration rules from an administration workstation, the orchestration rules defining flow logic for executing the plural scripts in a defined sequence; selecting one of the plural scripts; sending the selected script to an endpoint agent for execution by the endpoint agent; and receiving status information associated with execution of the script from the endpoint agent.

### BRIEF DESCRIPTION OF THE DRAWINGS

The foregoing will be apparent from the following more particular description of example embodiments of the subject innovation, as illustrated in the accompanying drawings in which like reference characters refer to the same parts throughout the different views. The drawings are not necessarily to scale, emphasis instead being placed upon illustrating embodiments of the subject innovation.

FIG. 1 is a block diagram that illustrates a network configuration in accordance with principles of the subject innovation.

FIG. 2 illustrates a process for workflow conversion, packaging and upload to a cloud-based provisioning service in accordance with principles of the subject innovation.

FIG. 3 illustrates a process for orchestrating script download and execution to an endpoint from the cloud-based provisioning service in accordance with principles of the subject innovation.

FIG. 4 illustrates a network configuration for event triggered workflows managed by the cloud-based provisioning service in accordance with principles of the subject innovation.

### DETAILED DESCRIPTION

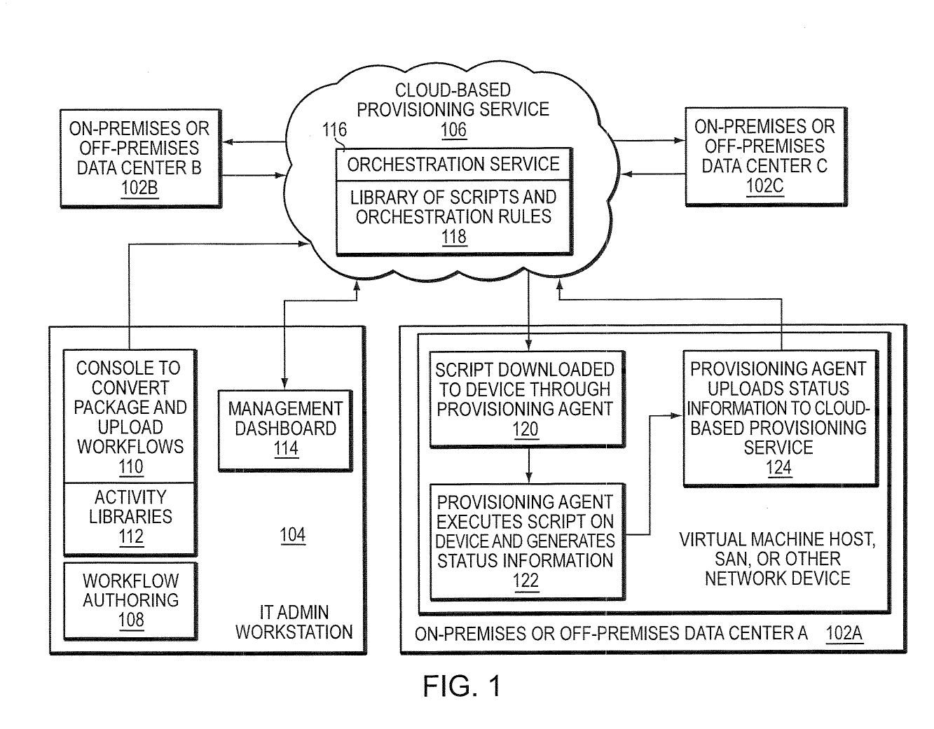

FIG. 1 illustrates an example network configuration in accordance with principles of the subject innovation. The network configuration includes data centers 102A, 102B, 102C in communication with a cloud-based service 106 and an IT administration workstation 104.

The secure, cloud-based service 106 is based on a computing paradigm in which a “cloud” of devices and services are configured to allow multiple clients or agents to be serviced simultaneously within the cloud without degradation to computing performance. The term “cloud” refers to a collection of data and resources (e.g., hardware and/or software, data storage services, data processing services) accessible by a user over a network and maintained by an off-site or off-premises party (e.g., a third-party). An example of a third-party offering for cloud-based hosting is Microsoft Windows Azure™.

A “workflow” generally refers to a depiction of a sequence of activities and operations of a person, work of a simple or complex mechanism, work of a group of persons, or machines.

“Resource automation” refers to a process by which human interaction with a technical resource, such as system management software for managing virtual machines or application software for managing application services, is replaced with a sequence of automation scripts that executes as defined by workflow orchestration rules the identical task without human intervention.

The IT administration workstation 104 hosts a workflow authoring application 108 (e.g., Citrix Workflow Studio or Microsoft Visual Studio®), a console application 110 which includes a workflow conversion engine and a management dashboard application 114. An IT administrator runs the workflow authoring application in conjunction with activity libraries 112 to author a workflow composed of a collection of individual activities from the activity libraries and then test a workflow that defines provisioning or tear down of a VM host, SAN, other network device or application services running on those VMs.

The console extension is a software application that integrates with workflow authoring applications such as Citrix Workflow Studio or Microsoft Visual Studio. It contains in it the functionality to convert a traditional workflow into a collection of scripts and orchestration rules. The console extension also contains the functionality to package and upload the collection of scripts and orchestration rules. The activity libraries are compiled DLLs that contain the individual activities that are assembled together to build a workflow.

Once tested, the IT administrator uses workflow conversion functionality of the console application to convert the workflow into a collection of scripts with associated orchestration rules. The management of activities through a workflow is referred to as orchestration service 116. The converted scripts and orchestration rules are packaged and uploaded to a cloud-based provisioning service. The cloud-based provisioning service uses cloud-based resources to store the converted scripts and orchestration rules 118.

The IT administrator runs the management dashboard application to schedule the converted workflow hosted in the cloud-based provisioning service to apply to VM hosts, SAN, other network devices and application services located in the data centers located on-premises or off-premises.

At the example data center 102A, each endpoint (e.g., VM host, SAN or other network device) in communication with the cloud-based provisioning service includes a provisioning agent. The cloud-based provisioning service downloads a script to the agent 120. The agent executes the script to generate status information 122. The agent uploads the status information 124 to the cloud-based provisioning service. The sequence of scripts sent to the agent for execution is controlled by the orchestration rules 118.

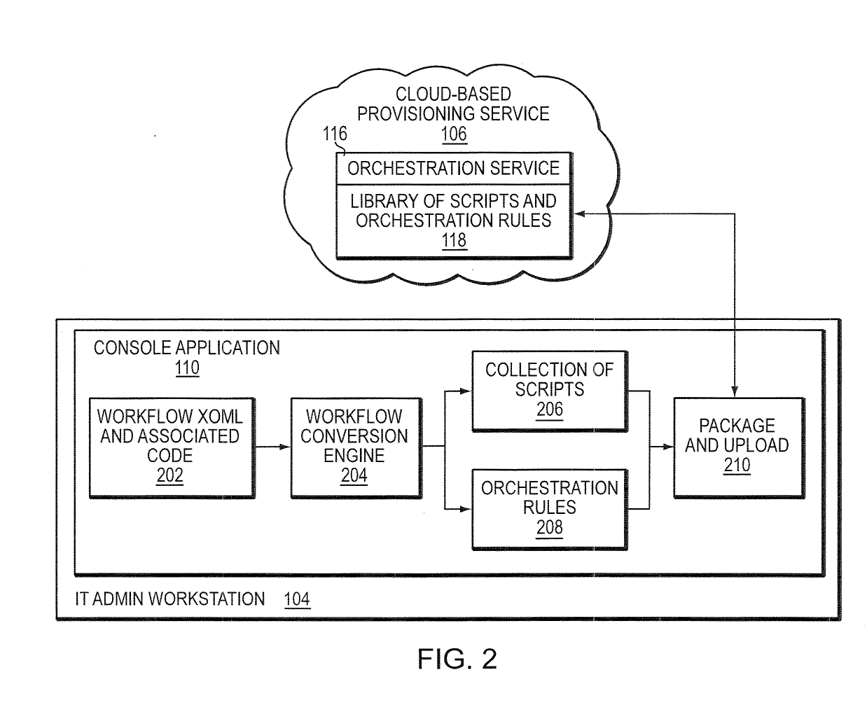

FIG. 2 illustrates the process for workflow conversion, packaging and upload to the cloud-based provisioning service provided by the console application which snaps into the workflow authoring application running on the IT administrator workstation.

The workflow authoring application, which may be based on Microsoft.NET Workflow Foundation, generates an Extensible Object Markup Language (XOML) file along with associated code 202. The XOML file and associated code is converted by a conversion engine 204 of the console application whereby each activity in the workflow is converted to a corresponding script 206. This process is repeated until all the activities within the workflow are converted to scripts.

The workflow conversion engine also generates orchestration rules 208. These orchestration rules capture the flow logic that is required to execute the scripts in the proper sequence.

The console application packages the collection of scripts and associated orchestration rules and uploads 210 the package to the cloud-based provisioning service.

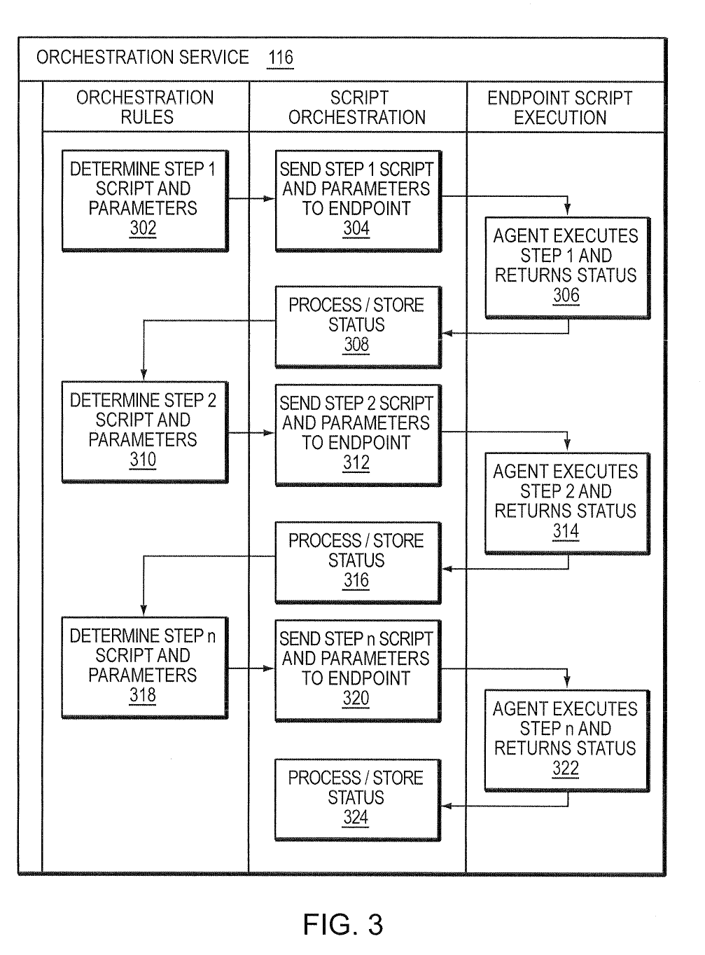

FIG. 3 illustrates an example process for orchestrating script download and execution to an endpoint from the cloud-based provisioning service.

The cloud-based provisioning service includes an orchestration service 116 that coordinates with the provisioning agent installed on the VM host, SAN or other network device endpoint to send a script with parameters 302, 304. Once the agent receives the script with parameters, it executes the scripts and collects output status information 306. The agent then sends the output status information to the orchestration service. The output status information includes a success or failure indicator and the parameters can be any type of data depending on what the script is requesting to be returned.

The orchestration service analyzes the output status information and stores the information in a database resource in the cloud 308. The orchestration service then references the orchestration rules to determine the next script and parameters 310, 312 to send to the agent. The next script with parameters are dynamically determined by the orchestration service and the end device to which the script is sent may be the same device or a different device within the same data center or located in a different data center, thereby enabling the single orchestration of devices regardless of physical location. The process repeats at step 316 and for n steps 318, 320, 322, 324.

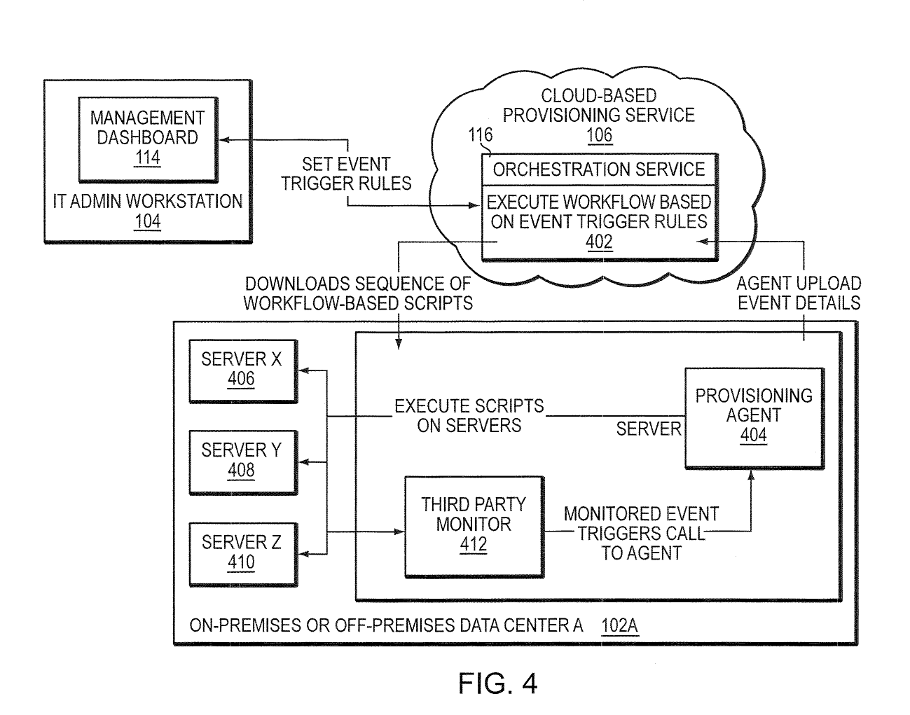

FIG. 4 illustrates a network configuration for event triggered workflows managed by the cloud-based provisioning service.

In this configuration, events captured from third party monitoring systems 412 such as Microsoft System Center Operations Manager are used to trigger execution of workflows. Key system health events may be monitored such that if the system becomes unhealthy, a workflow can be triggered to resolve the issue. For example, if the utilization of storage allocated to a server 406, 408, 410 exceeds a threshold, the IT administrator may want to trigger a workflow to provision additional storage. Other examples of monitored events include CPU utilization, memory utilization and website page response time.

The occurrence of an event monitored by the third party system 412 triggers a call to provisioning agent 404. The agent receives the event details from the third party system and uploads the event details to the cloud-based provisioning service which contains a set of rules 402 to execute a workflow. The rules may be set by the IT administrator through the management dashboard application 114 to execute the appropriate workflow based on the event details. The cloud-based provisioning service sends the agent a sequence of scripts to be executed based on the orchestration rules associated with the event-triggered workflow.

It should be noted that, illustrative embodiments of the subject innovation, described herein, are described as using the Microsoft Windows® operating system. The Microsoft Windows operating system is available from Microsoft Corporation. It should be noted that other operating systems may be adapted to be used with the subject innovation including e.g., Unix, and Linux.

It should be understood that the application server and the targeted computer system may each include a processor and memory. The memory may be a non-transitory computer readable medium organized as a random access memory (RAM) implemented using various RAM devices, such as dynamic random access memory (DRAM) devices. The memory may be configured to hold various computer executable instructions and data structures including computer executable instructions and data structures that implement aspects of the subject innovation. It should be noted that other non-transitory computer readable mediums, such as disk units and flash memory, may be configured to hold computer readable instructions and data that implement aspects of the subject innovation.

While the subject innovation has been particularly shown and described with references to example embodiments thereof, it will be understood by those skilled in the art that various changes in form and details may be made therein without departing from the scope of the subject innovation encompassed by the appended claims.

What is claimed is:

1. A computer implemented method comprising:
converting a workflow to plural resource automation scripts;
generating orchestration rules that define flow logic for executing the plural scripts in a defined sequence; and
sending the plural scripts and orchestration rules to a cloud-based service.

2. The method of claim 1 wherein the workflow includes plural activities and converting includes:
converting each activity to a corresponding script.

3. A computer implemented method comprising:
receiving a resource automation script from a cloud-based service;
executing the script;
generating status information associated with execution of the script; and
sending the script status information to the cloud-based service.

4. The method of claim 3 further comprising:
receiving a second script from the cloud-based service in response to the sent status information;
executing the second script;
generating status information associated with execution of the second script; and
sending the second script status information to the cloud-based service.

5. The method of claim 3 further comprising:
receiving event trigger information indicating occurrence of a particular monitored event;
sending the event trigger information to the cloud-based service; and
receiving the script in response to the sent event trigger information.

6. A computer implemented method of providing a cloud-based service, the method comprising:
receiving plural resource automation scripts and orchestration rules from an administration workstation, the orchestration rules defining flow logic for executing the plural scripts in a defined sequence;
selecting one of the plural scripts;
sending the selected script to an endpoint agent for execution by the endpoint agent; and
receiving status information associated with execution of the script from the endpoint agent.

7. The method of claim 6 further comprising:
selecting a second script of the plural scripts based on the received script status information;
sending the second script to the endpoint agent for execution by the endpoint agent; and
receiving status information associated with execution of the second script from the endpoint agent.

8. The method of claim 7 wherein selecting is based on the orchestration rules.

9. The method of claim 6 further comprising:
storing the plural scripts and orchestration rules to a storage resource of the cloud-based service.

10. The method of claim 6 wherein sending is responsive to receiving event trigger information from the endpoint agent.

11. A non-transitory computer-readable medium with an executable program stored thereon, wherein the program instructs a microprocessor to perform the following steps:
converting a workflow to plural resource automation scripts;
generating orchestration rules that define flow logic for executing the plural scripts in a defined sequence; and
sending the plural scripts and orchestration rules to a cloud-based service.

12. A non-transitory computer-readable medium with an executable program stored thereon, wherein the program instructs a microprocessor to perform the following steps:
receiving a resource automation script from a cloud-based service;
executing the script;
generating status information associated with execution of the script; and
sending the script status information to the cloud-based service.

13. A non-transitory computer-readable medium with an executable program stored thereon, wherein the program instructs a microprocessor to perform the following steps:
receiving plural resource automation scripts and orchestration rules from an administration workstation, the orchestration rules defining flow logic for executing the plural scripts in a defined sequence;
selecting one of the plural scripts;
sending the selected script to an endpoint agent for execution by the endpoint agent; and
receiving status information associated with execution of the script from the endpoint agent.

14. Apparatus comprising:
means for converting a workflow to plural resource automation scripts;
means for generating orchestration rules that define flow logic for executing the plural scripts in a defined sequence; and
means for sending the plural scripts and orchestration rules to a cloud-based service.

15. Apparatus comprising:
means for receiving a resource automation script from a cloud-based service;
means for executing the script;
means for generating status information associated with execution of the script; and
means for sending the script status information to the cloud-based service.

16. Apparatus comprising:
means for receiving plural resource automation scripts and orchestration rules from an administration workstation, the orchestration rules defining flow logic for executing the plural scripts in a defined sequence;
means for selecting one of the plural scripts;
means for sending the selected script to an endpoint agent for execution by the endpoint agent; and
means for receiving status information associated with execution of the script from the endpoint agent.
